(19) United States
(12) Patent Application Publication
(10) Pub. No.: US 2016/0275737 A1
(43) Pub. Date: Sep. 22, 2016

(54) Fetching device for fast and accurately fetching or caching items

(71) Applicants: Yi-Ren Cai, Tainan (TW); Huei-Ying Chiou, Tainan (TW)

(72) Inventors: Yi-Ren Cai, Tainan (TW); Huei-Ying Chiou, Tainan (TW)

(21) Appl. No.: 15/169,757

(22) Filed: Jun. 1, 2016

(30) Foreign Application Priority Data
May 20, 2016 (TW) 105115865

(51) Int. Cl. G07C 9/00; G06F 19/00; G06K 7/10

(52) U.S. Cl. CPC G07C 9/00126; G07C 9/00309; G06K 7/10366; G06F 19/3462; G07C 2009/00769

(57) ABSTRACT

Provided is a fetching device for fast and accurately fetching or caching items including an input device that can store signals of multiple types of items, an intermediate device having functions of accepting, converting and transmitting signals, and a receiving device that can indicate the location of the item. The signals of the items to be fetched or cached are sent to the input device. Then, the signal is submitted to the intermediate device. Upon receipt of the signal, the intermediate device will transmit the received signal to the receiving device. After receiving the signal, the receiving device will emit weak signal warning, such as analog light signals or sound, from the location of the item. The operator can easily identify the location of the item that need to be fetched or cached, and achieve the effect of fast and accurately fetching and caching item.

### BACKGROUND OF THE INVENTION

1. Field of the Invention

The invention relates to a fetching device, more specifically, a fetching device that can fast and accurately fetch or cache items through the help of databases and electronic devices.

2. Description of Related Art

To take the example of how the steps of retrieving medicine nowadays, the doctor prescribes the medicines first and the pharmacist retrieves the prescribed medicines accordingly, confirms the types and quantities of the medicines to be correct, then issues the prescribed medicine and, at the same time, explains the correct instructions on medication to the patient.

However, pharmacists face the following problems while fetching the medicines: Due to many types and the vast amount of medicines available, newly employed pharmacists and Locum pharmacists are unlikely able to get started immediately in different facility of pharmacy, resulting in difficulty in locating the prescribed medication, retrieving the wrong medication, or longer time required to fetch and dispense the medication.

Many medicines have similar names, appearance, dosage forms, dose, package, frequently leading to the mishandling of the medication and, as a result, possible danger. Especially, when pharmacists are under a tiredness condition, it is extremely difficult to guarantee that the inspection process is with complete accuracy.

While caching the stored medicines, mishandling or filling medicines into the wrong drawers in the store cabinets may occur under the extreme tiredness condition or demand of speedy operation, resulting in dispensing the medicines, different from the prescribed medicines, which can cause danger to the patient once consumed.

Thus, the need for improvement still exists.

### SUMMARY OF THE INVENTION

The objective of the invention is to: increase the accuracy of fetching or caching items by the inventory personnel through the search function of the input device and the prompting function of the receiving device, in order to put an end to the mistakes caused by human errors and to perfectly increase the efficiency and efficacy of the overall operation.

According to the aforementioned objective, the invention describes a fetching device for fast and accurately fetching and caching items, which comprises a compartment area, an input device, an intermediate device and receiving devices, wherein the compartment area is for storing items to be fetched or cached; the input device is for inputting multiple types of item signals and has the item location database, and can transmit the signals to the intermediate device through cables or the wireless methods; the intermediate device has the functions of accepting, converting and transmitting signals that come from the input device; the receiving devices are installed in the compartment area, can receive signals emitted from the intermediate device and can indicate the location of the item, wherein the item location database includes the information of item location in the compartment area of all items.

In addition, the item signals are item information codes for managing categorization and arrangement conveniently and can be roughly divided into: healthcare code, international code, store code and spare code.

Thus, the overall operational workflow of the fetching device for fast and accurately fetching and caching items is as follows:

The item signal codes are input to the input device via cable or the wireless method and the input device transmits the item signals to the intermediate device.

After the intermediate device has obtained the identification from the item signals, the item locations corresponding to the item signal codes are searched from the item location database, and the item signal codes are converted to the item location signals. After, the item location signals are transmitted to the receiving device.

After receiving signals, the receiving device will emit weak signal warning, such as analog light signals or sound, to indicate the correct location of item to be fetched or cached.

Thus, the fetching device can accurately and clearly indicate the item location that shall be fetched or cached, so that the operator can fetch the item accurately.

The above and other objects, features and advantages of the invention will become apparent from the following detailed description taken with the accompanying drawings.

### BRIEF DESCRIPTION OF THE DRAWINGS

FIG. 1 is a schematic diagram of the fetching device for fast and accurately fetching or caching items of the invention;

FIG. 2 is a schematic diagram of the intermediate device of the invention;

FIG. 3 is a schematic diagram of the receiving devices installed on the storage cabinet of the invention;

FIG. 4 is a schematic diagram of the drawers of the storage cabinet of the invention;

FIG. 5 is a schematic diagram of the embodiment of the input device and the intermediate device of the invention;

FIG. 6 is a schematic diagram of the embodiment of the intermediate device and the receiving device of the invention;

FIG. 7 is another schematic diagram of the embodiment of the intermediate device and the receiving device of the invention;

FIG. 8 is a schematic diagram of the embodiment of the operation of the invention; and

FIG. 9 is a schematic diagram of another form of storage cabinet of the invention.

### DETAILED DESCRIPTION OF THE INVENTION

The invention relates to a fetching device for fast and accurately fetching or caching items, especially suitable to be used in the storage related business, environment, and facilities. The following embodiments best represent the invention. These embodiments especially offer examples to explain how the invention is applied to the medical facilities.

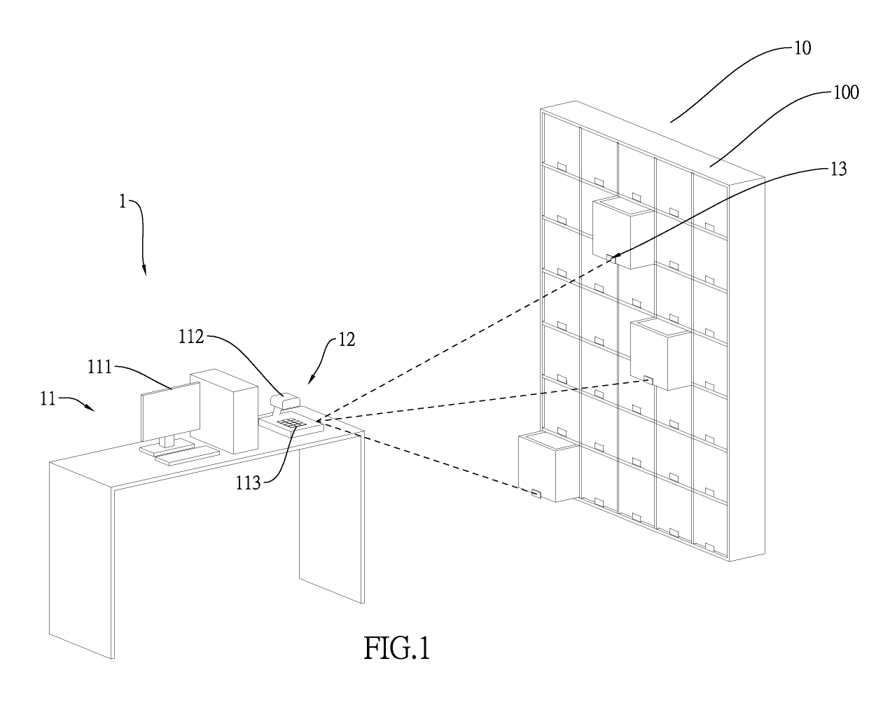

Referring to FIG. 1, it is the schematic diagram of the fetching device for fast and accurately fetching or caching items 1 of the invention.

According to this diagram, the fetching device for fast and accurately fetching or caching items 1 of the invention comprises of the compartment area 10, the input device 11, the intermediate device 12 and the receiving devices 13.

The aforementioned compartment area 10 is for storing items to be fetched or cached. The items in the embodiment are medicines and, at the same time, the compartment area can be the storage cabinet 100 for storing medicines as an example for illustration.

The aforementioned input device 11 comprises a database of multiple types of item signals and item location signals, and has the function of transmitting the signals to the intermediate device through cables or wireless methods.

The aforementioned intermediate device 12 can accept the medicine signals from the input device 11, convert the medicine signals into the medicine location signals, and have the function to transmit the medicine location signals to the receiving device 13.

The aforementioned receiving devices 13 are installed in the compartment area, can receive signals emitted from the intermediate device 12 and have the function of indicating the locations of the medicines, wherein the medicine location database includes the information of medicine locations in the storage cabinet 100 of all medicines.

In addition, the medicine signals are medicine information codes for managing categorization and arrangement conveniently and can be roughly divided into: healthcare code, international code, store code and spare code.

Thus, the input device 11 of the invention generally refers to the electronic device, which comprises a computer 111, having the function of transmitting signals through cables or the wireless method, and a barcode scanner 112 or a radio frequency identification (RFID) device 113, wherein the barcode scanner 112 or the radio frequency identification (RFID) device 113 is at time suitably chosen as the scanner for scanning one-dimensional or two-dimensional barcodes.

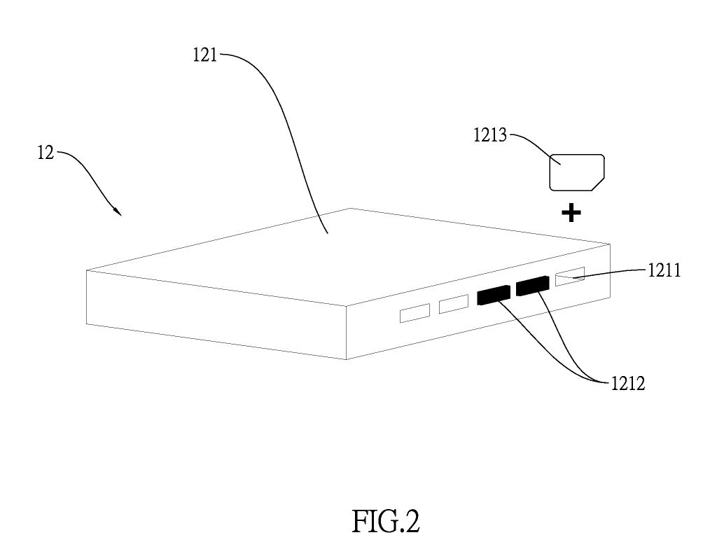

Referring to FIG. 2, it is the schematic diagram of the intermediate device of the invention. As illustrated in the diagram, the intermediate device 12 at time has a memory unit 121. The memory unit 121 has a memory card slot and selector buttons 1212 thereon, which provide the option of emitting a single signal or multiple signals simultaneously. The aforementioned memory card slot 1211 can be inserted with a corresponding memory card 1213 that stores the medicine location database.

Continuously, the operation method of the intermediate device 12 is as follows: directly accept the medicine signals transmitted by the input device 11 (computer 111) under the condition of being connected to the input device 11 (computer 111), or accept the medicine signals through the input device 11 (a barcode scanner 112 or a radio frequency identification (RFID) device 113) under the condition of being offline; match the medicine signals with the corresponding medicine location signals in the medicine location database; next, convert the medicine signals to the medicine location signals and transmit the medicine location signals to the receiving devices 13.

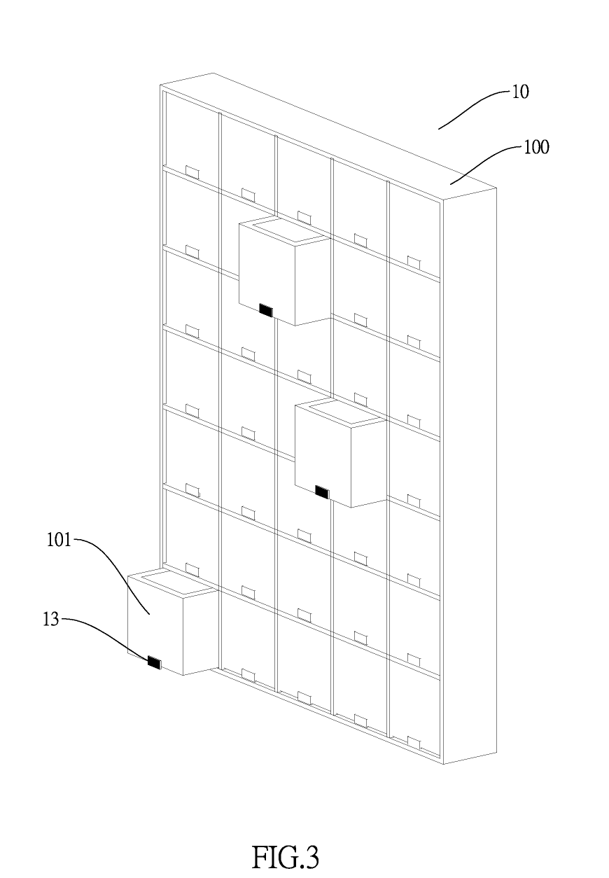

Referring to FIG. 3, it is the schematic diagram of the receiving devices 13 installed on the storage cabinet 100 of the invention. As illustrated in the diagram, the storage cabinet 100 has a plurality of drawers 101 and the receiving devices 13 can be installed on the storage cabinet 100 or installed individually installed on the drawers 101 of the storage cabinet 100 (the example of individual installation shown in the figure). The storage cabinet 100 can also have the ejecting devices for ejecting the drawers 101 (not illustrated in the figure) wherein the ejecting devices are electrically connected to the receiving devices 13. In addition, the receiving devices 13 at time can be the weak signal warning device, emitting analog light signals or sound, so that the receiving device will generate analog light signals or sound while receiving the medicine location signal. At the same time, the drawer 101 will automatically eject from the storage cabinet, allowing pharmacists to fetch the medicine more conveniently.

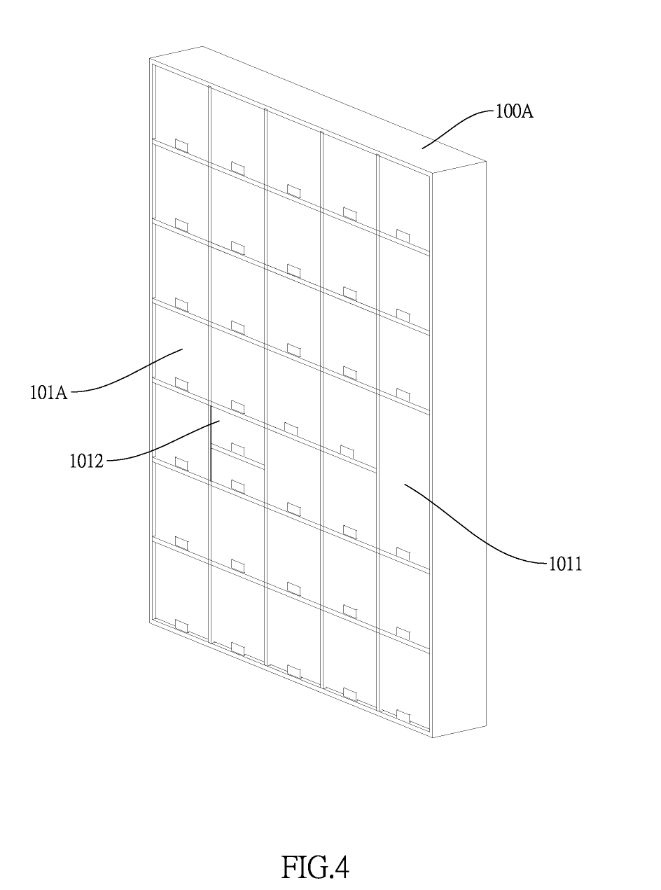

Referring to FIG. 4, it is the schematic diagram of the drawer 101A of the storage cabinet 100A of the invention. As illustrated in the diagram, the space and size the drawer 101A of the storage cabinet 100A can be adjusted in accordance with the size and volume of the medicine accordingly. The drawer 101A can be replaced with drawers of proper sizes. For example, for a bigger internal capacity, a drawer with large capacity 1011 is used; for a smaller internal capacity, a drawer with small capacity 1012 is used.

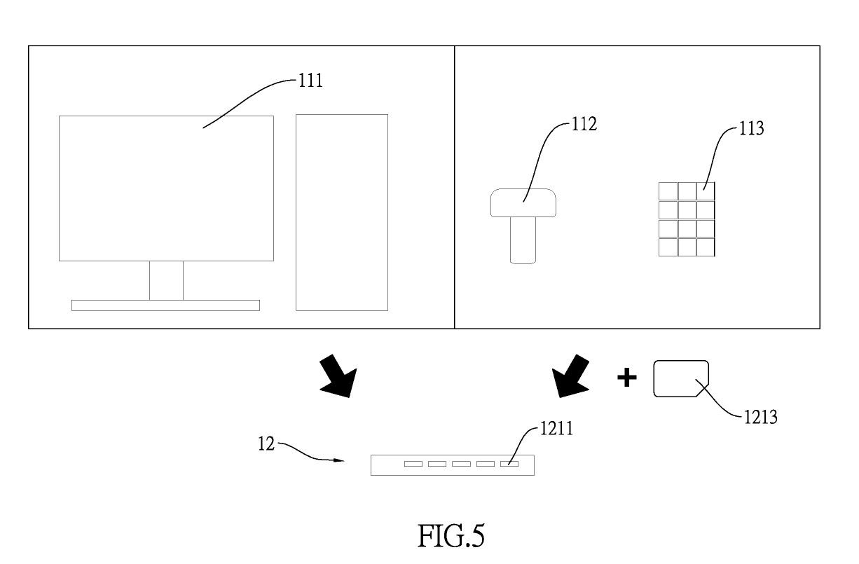

Referring to FIG. 5, it is the schematic diagram of the embodiment of the input device 11 and the intermediate device 12 of the invention. When the invention is in operation, there are two methods for the intermediate device 12 to obtain the item location signals:

Under the condition of being connected to the computer 111 directly, accept the medicine location signals transmitted by the computer 111; under the condition of being offline, insert the memory card 1213 containing the medicine location database into the memory card slot 1211 installed on the intermediate device 12 (or other devices that have the function of storing to or retrieving from the memory); input the medicine information through the barcode scanner 112 or the radio frequency identification (RFID) device 113; after the medicine signals being converted into the medicine location signals by the intermediate device 12, the signals are transmitted to the receiving devices 13.

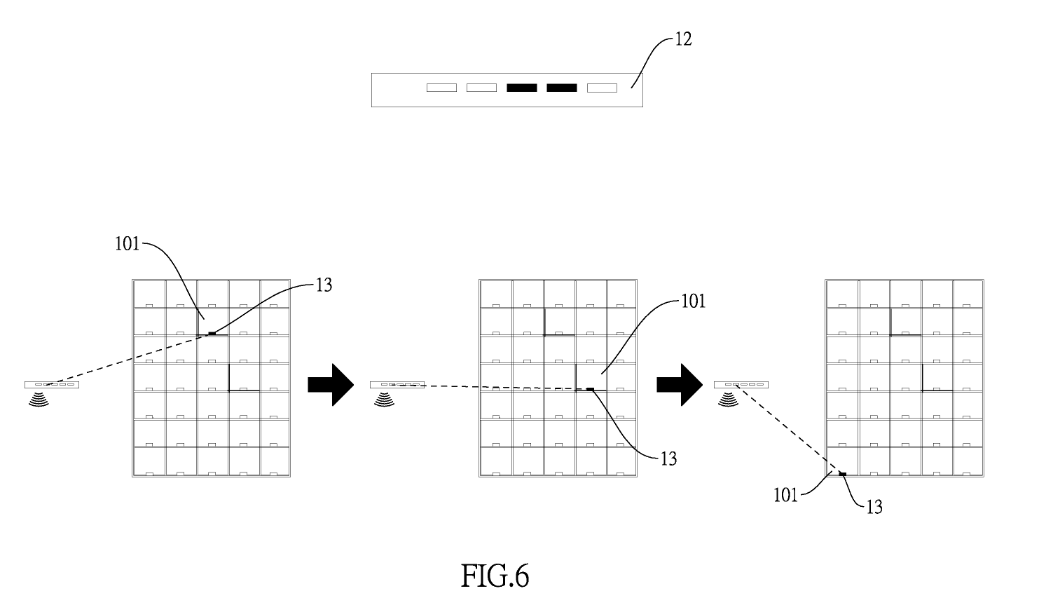

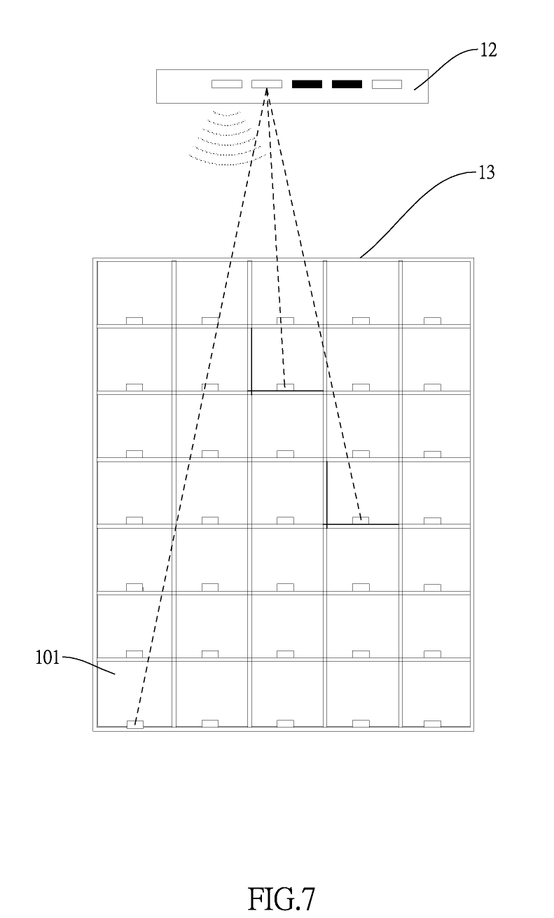

Referring to FIGS. 6 and 7 in which FIG. 6 is a schematic diagram of the embodiment of the intermediate device 12 and the receiving device 13 of the invention, and FIG. 7 is another schematic diagram of the embodiment of the intermediate device 12 and the receiving device 13 of the invention.

As shown in FIG. 6, when the operator uses the intermediate device 12, if the option of emitting a single signal is selected, the intermediate device 12 will emit a single medicine location signal to the receiving device 13. When the receiving device 13 receives the signal, not only the receiving device will generate weak warning signals, such as analog light signals or sound, as notification, but also the drawer 101 will automatically eject from the storage cabinet, allowing pharmacists to fetch the medicine more conveniently.

As shown in FIG. 7, when the operator uses the intermediate device 12, if the option of emitting multiple signals is selected, the intermediate device 12 will emit a plurality of medicine location signals to the receiving devices 13. When the receiving devices 13 receive the signals, not only the receiving devices will generate weak warning signals, such as analog light signals or sound, as notification, but also the drawers 101 will automatically eject from the storage cabinet, allowing pharmacists to fetch the medicine more conveniently.

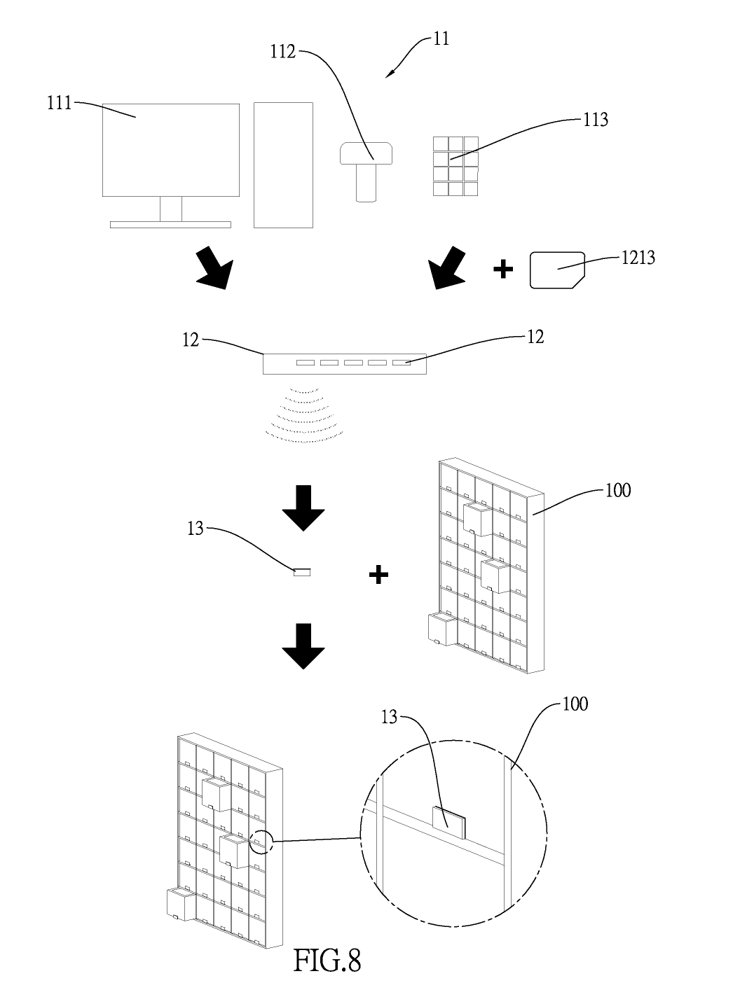

Referring to FIG. 8, it is the schematic diagram of the embodiment of the operation of the invention. As shown in FIG. 8, the complete workflow of fetching the medicine of the invention is: Through the input device 11, the medicine signals are transmitted to the intermediate device: Under the condition of being connected online, the computer 111, having the signal transmission function via cables or the wireless method, directly transmits the medicine signals to the intermediate device 12; under the condition of being offline, insert the memory card 1213 containing the medicine location database into the memory card slot 1211 installed on the intermediate device 12 (or other devices that have the function of storing to or retrieving from the memory); then input the medicine information through the barcode scanner 112 or the radio frequency identification (RFID) device 113 and the medicine signals are transmitted to the intermediate device 12.

The medicine signals are converted into the medicine location signals through the intermediate device 12; the signals are then transmitted to the receiving devices 13.

When the receiving device 13 receives the signal transmitted by the intermediate device 12, the receiving device will generate analog light signals or sound as notification; with the ejecting device electrically connected with the receiving device 13, the drawer 101 can automatically eject from the storage cabinet.

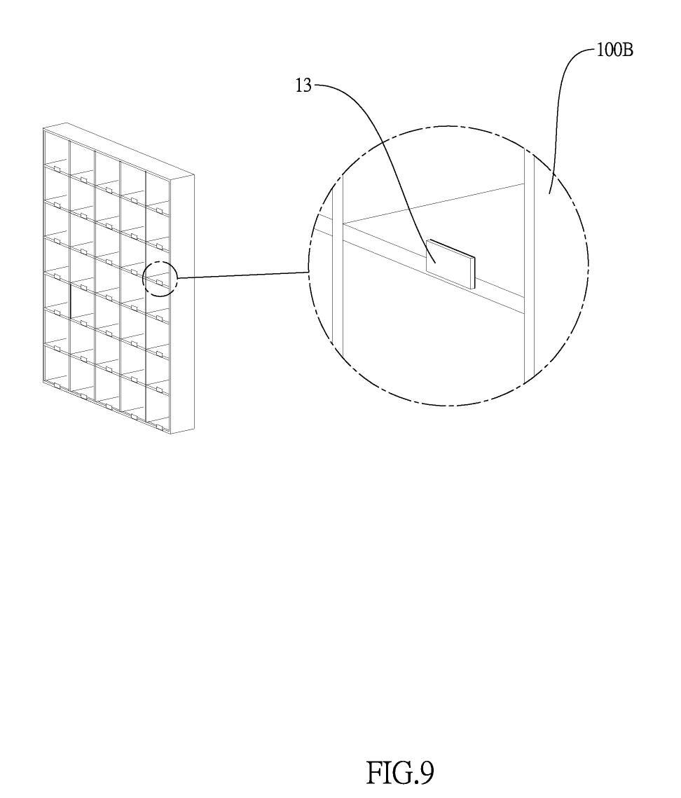

Referring to FIG. 9, it is the schematic diagram of another form of storage cabinet 100B of the invention. According to the diagram, the storage cabinet 100 can be replaced by the storage cabinet 100B with no drawer. The storage cabinet can be used for storing patients' medical records (or other hard copy records). The medical personnel can directly input patient's information (such as name, date of birth, etc.) through the input device 11 to the intermediate device 12; the intermediate device 12 transmits the record location signals to the receiving device 13; after receiving the signals, the receiving device 13 emits analog light signals or sound, to notify the medical personnel, thus to increase the speed of locating the medical records by the medical personnel.

In summary, the advantages of the fetching device for fast and accurately fetching or caching items of the invention are as follows: When the invention is applied to the medical facilities, the operator can get started immediately in different facility of pharmacy. Through the help of the input device to locate the medicine, the receiving device to notify the precise location of the prescribed medication, the operator can easily retrieve the correct medicines. Therefore, the time to retrieve the medicines and dispense the medication is shortened. The operation provides an efficient implementation. Since the receiving device can prompt with warning signals, the condition of other medicines mistakenly being retrieved can be avoided. As a result, the workflow of fetching medicines can be simplified and more effective. When the invention is applied to cache the medicines, if a medicine is to be located from the storage cabinet for caching, the medicine can be fetched easily without mistakenly being replaced with other medicines. Thus, errors can be minimized during the process when the pharmacist hands the patient with the wrong medication instead of the correct prescribed medication.

While the invention has been described in terms of preferred embodiments, those skilled in the art will recognize that the invention can be practiced with modifications within the spirit and scope of the appended claims.

What is claimed is:

1. A fetching device for fast and accurately fetching and caching items comprising a compartment area, an input device, an intermediate device, and receiving devices, wherein:
the compartment area is for storing items to be fetched or cached;
the input device comprises multiple types of item signals and the item location database, and transmits the signals to the intermediate device through cables or the wireless methods;
the intermediate device has the functions of accepting, converting and transmitting signals that come from the input device;
the receiving devices are installed in the compartment area, can receive signals emitted from the intermediate device and can indicate the location of the item;
the item location database includes the information of item location in the compartment area of all items; and
the item signals are item information codes for managing categorization and arrangement conveniently and can be roughly divided into: healthcare code, international code, store code and spare code.

2. The fetching device for fast and accurately fetching and caching items as claimed in claim 1, wherein the compartment area can be a storage cabinet for storing medicines.

3. The fetching device for fast and accurately fetching and caching items as claimed in claim 1, wherein the input device can be a computer, or a barcode scanner, or a radio frequency identification (RFID) device.

4. The fetching device for fast and accurately fetching and caching items as claimed in claim 3, wherein the barcode scanner or the radio frequency identification (RFID) device can scan one-dimensional or two-dimensional barcodes.

5. The fetching device for fast and accurately fetching and caching items as claimed in claim 1, wherein the intermediate device has a memory unit that can store and retrieve the signal information.

6. The fetching device for fast and accurately fetching and caching items as claimed in claim 5, wherein the memory unit has a memory card slot, allowing the portable memory card to be inserted in order to store and retrieve the signal information in the memory unit.

7. The fetching device for fast and accurately fetching and caching items as claimed in claim 1, wherein the receiving device is a weak signal warning device.

8. The fetching device for fast and accurately fetching and caching items as claimed in claim 7, wherein the weak signal warning device can generate a single signal or multiple signals of analog light or sound.

9. The fetching device for fast and accurately fetching and caching items as claimed in claim 2, wherein the storage cabinet has a plurality of drawers and each drawer is independently installed with a plurality of receiving devices.

10. The fetching device for fast and accurately fetching and caching items as claimed in claim 8, wherein the storage cabinet has a plurality of drawers and each drawer is independently installed with a plurality of receiving devices.

11. The fetching device for fast and accurately fetching and caching items as claimed in claim 9, wherein the storage cabinet further has the ejecting devices that can eject the drawers, and the ejecting devices are electrically connected with the receiving devices.

12. The fetching device for fast and accurately fetching and caching items as claimed in claim 10, wherein the storage cabinet further has the ejecting devices that can eject the drawers, and the ejecting devices are electrically connected with the receiving devices.
